(19) United States
(12) Patent Application Publication
(10) Pub. No.: US 2025/0291781 A1
(43) Pub. Date: Sep. 18, 2025

(54) MANAGEMENT METHOD AND DATABASE DEVICE

(71) Applicant: Kioxia Corporation, Tokyo (JP)

(72) Inventors: Shinichi KANNO, Ota Tokyo (JP); Toru WATABE, Yokohama Kanagawa (JP)

(21) Appl. No.: 19/074,239

(22) Filed: Mar. 7, 2025

(30) Foreign Application Priority Data
Mar. 18, 2024 (JP) 2024-042488

(51) Int. Cl. G06F 16/22; G06F 16/245

(52) U.S. Cl. CPC G06F 16/2237; G06F 16/245

(57) ABSTRACT

A first vector database stored in a storage device includes a group of first information pieces each indicating one of a plurality of first vectors that correspond to a plurality of nodes of a first directed graph. A management method is capable of reducing the amount of data written in the storage device during updates. The method includes, while generating a second directed graph that includes two or more nodes corresponding to two or more second vectors, generating, in a volatile memory, a second vector database in which a group of third information pieces each indicating one of the two or more second vectors, is recorded. The method further includes combining the first directed graph with the second directed graph by updating one information piece of the group of first information pieces and the group of third information pieces, and storing the second vector database in the storage device.

### CROSS-REFERENCE TO RELATED APPLICATION(S)

This application is based upon and claims the benefit of priority from Japanese Patent Application No. 2024-042488, filed Mar. 18, 2024, the entire contents of which are incorporated herein by reference.

### FIELD

Embodiments described herein relate generally to a management method and a database device.

### BACKGROUND

A vector database is a database that manages data in a vector format. The vector database enables a search operation such as an approximate nearest neighbor search (ANNS). A known example of ANNS algorithms is DiskANN (Disk-based Approximate Nearest Neighbor search).

According to DiskANN, a group of vector data is placed in a storage device, and index information that defines a directed graph corresponding to the group of vector data is placed in a volatile memory. Then, vector data that is closest to a query is searched along the directed graph defined by the index information.

### BRIEF DESCRIPTION OF THE DRAWINGS

FIG. 1 is a diagram illustrating an example configuration of a database device according to a first embodiment.

FIG. 2 is a diagram illustrating an example configuration of an SSD included in the database device according to the first embodiment.

FIG. 3 is a diagram illustrating an example configuration of a memory die according to the first embodiment.

FIG. 4 is a diagram illustrating an example configuration of a block according to the first embodiment.

FIG. 5 is a diagram for describing an example of a directed graph corresponding to a group of vector data managed by a vector database according to the first embodiment.

FIG. 6 is a diagram illustrating an example configuration of the vector database according to the first embodiment.

FIG. 7 is a diagram for describing how a new node is added according to the first embodiment.

FIG. 8 shows diagrams for describing operations from generating a partial database to storing the partial database in the SSD, according to the first embodiment;

FIG. 9 is a diagram for describing a search operation when a partial directed graph is added on the upstream side of the directed graph.

FIG. 10 is a diagram for describing a search operation when a partial directed graph is added on the downstream side of the directed graph.

FIG. 11 is a diagram for describing a search operation when a partial directed graph is added to a body portion of the directed graph.

FIG. 12 is a flow chart illustrating an example operation of the database device according to the first embodiment.

FIG. 13 is a flow chart illustrating an example operation of when a new node is added to the database device according to a second embodiment.

FIG. 14 is a diagram for describing a search operation according to the second embodiment.

FIG. 15 is a diagram illustrating an example of how the SSD is used in the database device according to a first modification.

FIG. 16 shows diagrams illustrating examples of how the SSD is used in the database device according to a second modification.

### DETAILED DESCRIPTION

Embodiments provide a management method and a database device capable of reducing the amount of data written in a storage device.

In general, according to one embodiment, a management method includes: storing a first vector database in a storage device; and generating a second vector database in a volatile memory. A group of first information pieces each indicating each of a plurality of first vectors is recorded in the first vector database. The plurality of first vectors correspond to a plurality of nodes of a first directed graph. Each first information piece included in the group of first information pieces includes one of the plurality of first vectors and a second information piece that indicates a vector corresponding to a neighbor node. While generating a second directed graph that includes two or more nodes corresponding to two or more second vectors, the second vector database in which a group of third information pieces each indicating one of the two or more second vectors, is recorded, is generated in the volatile memory. Each third information piece included in the group of third information pieces includes one of the two or more second vectors and a fourth information piece that indicates a vector corresponding to a neighbor node. The management method further includes combining the first directed graph with the second directed graph by updating at least one information piece of the group of first information pieces and the group of third information pieces, and storing the second vector database in the storage device.

A management method and a database device according to embodiments will now be described in detail with reference to accompanied drawings. Note that the present invention is not limited to the embodiments.

### First Embodiment

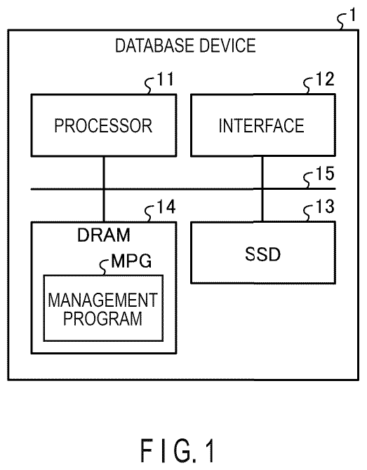

FIG. 1 is a diagram illustrating an example configuration of a database device according to a first embodiment.

In an example illustrated in FIG. 1, a database device 1 includes a processor 11, an interface 12, a solid-state drive (SSD) 13, a dynamic random access memory (DRAM) 14, and a bus 15. The processor 11, the interface 12, the SSD 13, and the DRAM 14 are electrically interconnected through the bus 15.

The interface 12 is a device for inputting and outputting information to and from the database device 1. The interface 12 includes an interface that enables communication with an external device through a network, an interface to which a storage device can be connected, and an interface to which an input device such as a keyboard can be connected. The database device 1 can accept an input of a query received from the outside through the interface 12. The database device 1 can also accept an input of new vector data received from the outside through the interface 12. Furthermore, the database device 1 may accept an input of data in any format such as text data or image data through the interface 12 and generate new vector data based on the input data.

The SSD 13 is a large capacity non-volatile memory device that functions as a storage device in the database device 1. The SSD 13 includes, for example, a non-volatile memory such as a NAND flash memory as a storage device.

The DRAM 14 is a volatile memory that operates faster than the storage device. The DRAM 14 functions as a cache area, a buffer area, a work area, or the like. Note that a volatile memory applicable to the database device 1 is not limited to a DRAM.

The processor 11 is a computing device that can execute a computer program to achieve functionality defined by the computer program. The processor 11 is, for example, a central processing unit (CPU). Here, more than one processor 11 may be provided depending on the functionality to be achieved. In the database device 1, the processor 11 executes the management of a vector database based on a management program MPG. The management of the vector database includes an operation of adding new vector data to the vector database and a search operation in response to a query input. For example, the management program MPG is stored in the SSD 13 or a device external to the database device 1. The processor 11 loads the management program MPG into the DRAM 14 from the SSD 13 or the device external to the database device 1 in an environment provided by the operating system. The processor 11 then executes the management program MPG loaded in the DRAM 14. Here, in the example illustrated in FIG. 1, the management program MPG is stored in the SSD 13.

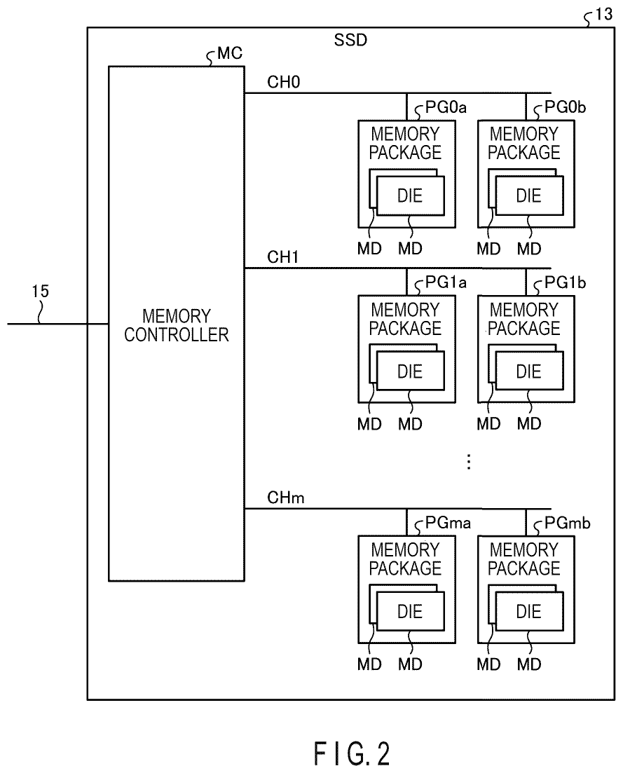

FIG. 2 is a diagram illustrating an example configuration of the SSD 13 included in the database device 1 according to the first embodiment.

The SSD 13 includes a memory controller MC and a plurality of memory packages PG. Each of the plurality of memory packages PG includes a plurality of memory dies MD, each of which is a NAND flash memory.

The memory controller MC and the plurality of memory packages PG are connected together through one or more channels. Here, as an example, the SSD 13 includes (m+1) channels CH0 to CHm, and two memory packages PG are commonly connected to each channel. For example, memory packages PG0a and PG0b are connected to the channel CH0, memory packages PG1a and PG1b are connected to the channel CH1, and memory packages PGma and PGmb are connected to the channel CHm. Each memory package PG includes two memory dies MD.

Note that the number of channels included in the SSD 13, the number of memory packages PG included in the SSD 13, the number of memory dies MD included in each memory package PG, and wirings between the memory controller MC and each memory die MD are not limited to the ones given in the example.

The memory controller MC may be built as an SoC (System-on-a-Chip). Alternatively, the memory controller MC may be built by means of a plurality of chips. A part or the entirety of memory controller MC may be built also as an FPGA (Field-Programmable Gate Array) or an ASIC (Application Specific Integrated Circuit).

The memory controller MC stores data input through the bus 15 to any of the memory dies MD or outputs data read from any of the memory dies MD through the bus 15.

Furthermore, the memory controller MC provides a logical address space to the outside of the SSD 13 (for example, processor 11). The memory controller MC manages a correspondence between a logical address that indicates a location in the logical address space and a physical address that indicates a location in a storage area included in a group of memory dies MD by using predetermined management information. The management information is referred to as, for example, a logical conversion table or a look-up table. The physical address indicates a memory package PG, a memory die MD, a block BLK, a page P, and a location in a page P. The block BLK and the page P will be described later. The processor 11 uses the logical address to designate a location for performing write or read. The memory controller MC identifies the location for performing write or read by converting the logical address into the physical address.

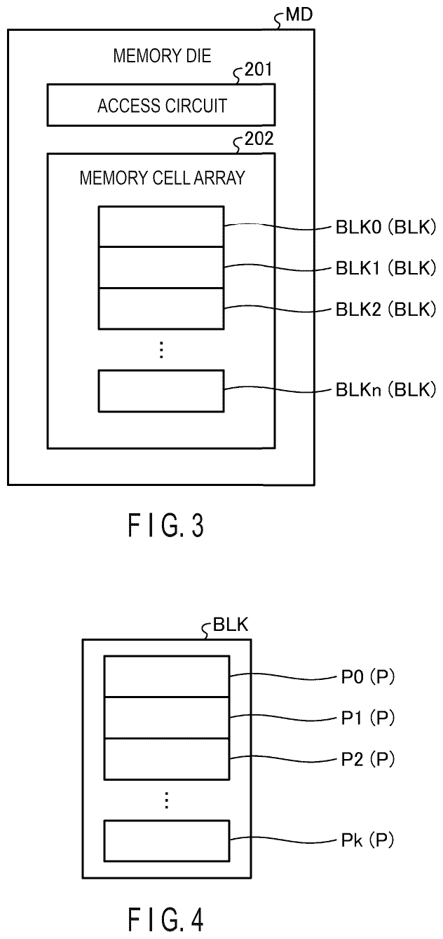

FIG. 3 is a diagram illustrating an example configuration of a memory die MD according to the first embodiment.

The memory die MD includes an access circuit 201 and a memory cell array 202.

The memory cell array 202 includes a plurality of blocks BLK. In the example illustrated in FIG. 3, the memory cell array 202 includes (n+1) blocks BLK0 to BLKn as the plurality of blocks BLK.

Each block BLK includes a plurality of memory cell transistors. Each memory cell transistor is associated with a row and a column. The plurality of memory cell transistors can store data.

The access circuit 201 includes, for example, a signal processing circuit, a row decoder, a column decoder, a sense amplifier, a latch circuit, and a voltage generation circuit. The access circuit 201 executes an access to the memory cell array 202 in accordance with a command received from the memory controller MC. The access includes data write, data read, and data erase.

The data erase is executed per unit of block BLK. In other words, data stored in one block BLK is to be erased collectively. The data write and data read are executed per unit of page P, which is smaller than the block BLK.

FIG. 4 is a diagram illustrating an example configuration of a block BLK according to the first embodiment.

The block BLK includes a plurality of pages P. In the example illustrated in FIG. 4, the block BLK includes (k+1) pages P0 to Pk as the plurality of pages P. The access circuit 201 can execute data write and data read to and from the memory cell array 202 per unit of page P. In other words, the page P is a unit storage area for data write and data read in the SSD 13.

In the database device 1, a group of vector data constituting a directed graph is managed as a vector database DB. The directed graph refers to a graph configured such that each piece of vector data included in the group of vector data is considered as a node and nodes are connected by a directed edge.

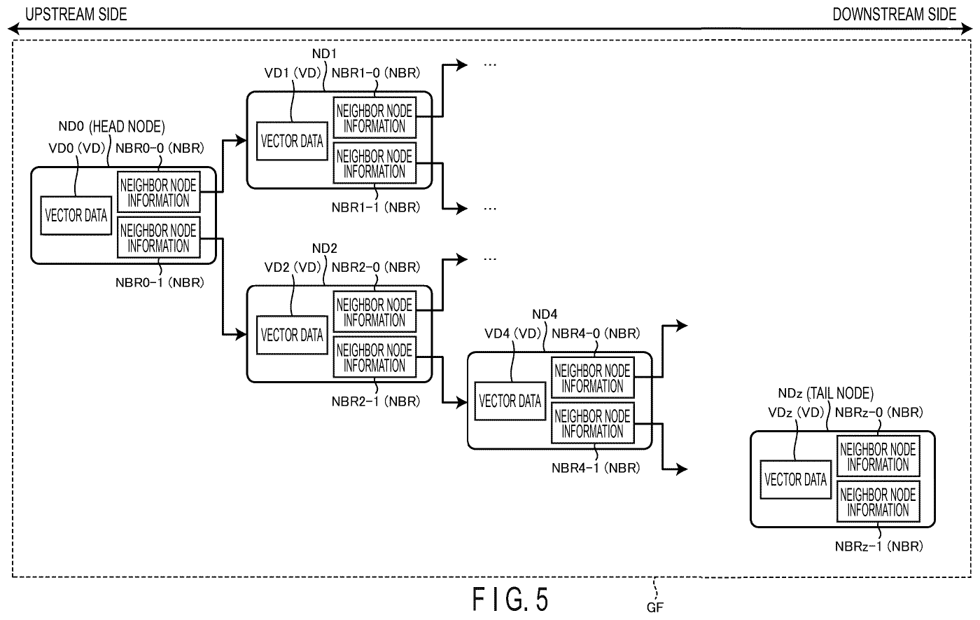

FIG. 5 is a diagram for describing an example of a directed graph GF corresponding to the group of vector data managed by the vector database DB according to the first embodiment.

Each piece of vector data included in the group of vector data is considered as a node ND. Information on each node ND (hereinafter, node information) includes corresponding vector data and neighbor node information. The neighbor node information is information that indicates a neighbor node, more specifically, an outgoing neighbor node (out-neighbor).

For example, a certain node ND0 is connected to each of a node ND1 and a node ND2. The node ND1 and the node ND2 are outgoing neighbor nodes of the node ND0. Accordingly, the node information associated with the node ND0 includes neighbor node information NBR0-0 that indicates a connection with the node ND1 and neighbor node information NBR0-1 that indicates a connection with the node ND2 in addition to vector data VD0 for the node ND0.

In the explanation of the directed graph GF, a node ND on the most upstream side of the directed graph is denoted as a head node, and a node ND on the most downstream side of the directed graph is denoted as a tail node. In the directed graph, a segment from immediately after the head node to immediately before the tail node is denoted as a body portion. For example, the node ND0 corresponds to the head node of the directed graph GF and the node NDz corresponds to the tail node of the directed graph GF. The segment from immediately after the node ND0 to immediately before the node NDz corresponds to the body portion.

Here, in the example illustrated in FIG. 5, the directed graph GF has a tree shape, and the out-degree of each node ND is 2. The shape of the directed graph GF is not limited to the tree shape. The out-degree may not be common in a plurality of nodes ND. Within the directed graph GF, while the out-degree of most of the node ND is 1 or more than 1, there may be a node whose out-degree is 0.

The directed graph GF is used in the search operation. In the search operation, the processor 11 executes computation for searching for a node ND that has a distance closest to a query following the directed graph GF based on any search algorithms. As a computation algorithm for the search, any algorithms may be adopted, including Greedy search, Beam search, and the like. To briefly explain an example, the processor 11 sequentially switches between search target nodes, each of which is a candidate for a node ND that has a distance closest to a query, among a plurality of nodes ND along the directed graph GF. Every time the search target nodes are switched, the processor 11 calculates the distance between each neighbor node of the search target node and the query. Then, the processor 11 sets, as the next new search target node, a node that is closest to the query among one or more neighbor nodes of one or more search target nodes that are currently close to the query. The processor 11 sequentially switches between the search target nodes along the directed graph GF until a node ND that is assumed to be the closest to the query is reached. The process of switching between the search target nodes along the directed graph GF may be referred to as “hop”. In other words, it can be considered that the directed graph GF represents a path along which a hop is possible.

Note that, in the specification, the distance is a measure indicative of a similarity between pieces of data (e.g., between the vector data ND and the query). Mathematically, the distance is, for example, the Euclidean distance. Note that the mathematical definition for the distance is not limited to the Euclidean distance. Furthermore, an indicator used to evaluate the distance is not limited to Euclidean distance or the like, and any indicator may be used as long as it corresponds to the distance.

A technique comparable to the first embodiment will be described (comparative example). According to the comparative example, the search operation is executed in accordance with DiskANN. That is, index information in which neighbor node information of each node is recorded for all nodes constituting the directed graph is stored in a DRAM, and the group of vector data is stored in a storage device. The hop is performed based on the index information.

However, as the group of vector data is scaled up, the index information is scaled up. Accordingly, according to the comparative example, as the group of vector data is scaled up, the required capacity of the DRAM also increases.

In the first embodiment, the node information that includes the vector data VD and the neighbor node information NBR associated with the vector data VD is recorded for each node in the vector database DB per vector data VD (in other words, per node ND). Then, for each hop, the node information associated with a node ND, which is a hop destination, is acquired from the vector database DB, and the vector data VD included in the acquired node information is used to calculate the distance. Then, the neighbor node information NBR included in the acquired node information is used for a hop. In this way, it is not necessary to hold the neighbor node information in the DRAM 14 for all nodes ND, so that the storage capacity required for the DRAM 14 is reduced as compared to the comparative example.

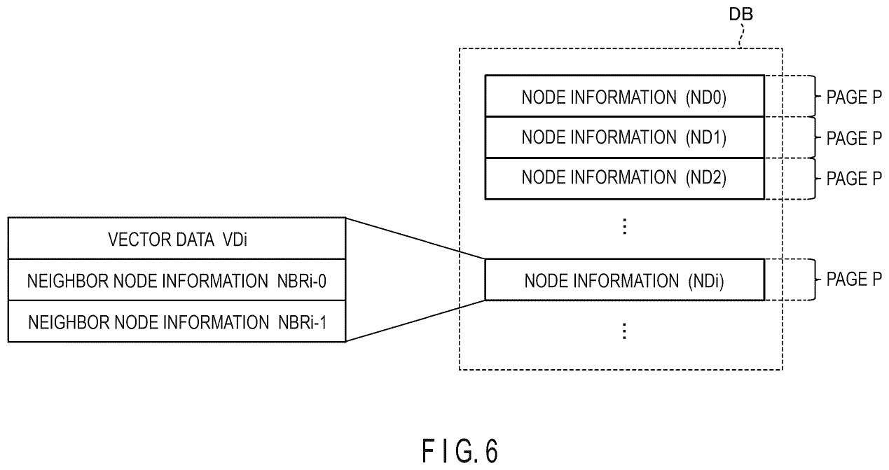

FIG. 6 is a diagram illustrating an example configuration of the vector database DB according to the first embodiment. As illustrated in the figure, the vector database DB is configured such that the node information is recorded per node ND. Each piece of node information is an information piece, which is an element of the vector database DB.

All pieces of node information have a common configuration. As a representative of all the node information, the configuration of the node information of a certain node NDi will be described.

The node information of the node NDi includes vector data VDi of the node NDi, and neighbor node information NBR for all neighbor nodes of the node NDi. Here, the node information of the node NDi includes neighbor node information NBRi-0 and neighbor node information NBRi-1.

All pieces of node information constituting the vector database DB are each stored in one page P individually. A read operation from the memory cell array 202 is executed per unit of page P, and therefore, each piece of node information is acquired by performing read from the memory cell array 202 at one time. Accordingly, it is possible to minimize time required for acquiring each piece of node information.

The neighbor node information NBR included in the node information indicates a neighbor node. The phrase “indicating the neighbor node” means that the exact location at which the node information of the neighbor node is stored is indicated or that the information with which the location at which the node information of the neighbor node is stored can be derived. For example, the neighbor node information NBR may be a logical address that indicates a location at which the node information of the neighbor node is stored.

In the following, the node ND and the vector data VD are treated as being synonymous. Since the vector database DB includes a group of neighbor node information NBR, which is information that defines the structure of the directed graph GF, the vector database DB and the directed graph GF are treated as being synonymous.

Each piece of node information includes the neighbor node information NBR that indicates a neighbor node. Accordingly, when a new node ND is added to the vector database DB, it may be necessary to update any of existing node information stored in the vector database DB. That is, when a new node ND is added as a neighbor node of an existing node ND, it is necessary to update the neighbor node information NBR of the existing node ND.

In the NAND flash memory employed in SSD or the like, as the number of execution of a cycle of write and erase increases, memory cell transistors will exhibit fatigue and the reliability of data stored in the memory cell transistors will degrade. Accordingly, there is a need for reducing the amount of data written in the NAND flash memory as much as possible.

When a new node ND is added to the vector database DB, a new write operation to one page P occurs for updating the node information of the existing node ND. More specifically, the node information with updated neighbor node information NBR included therein is written in an available page P. In other words, in addition to a write operation for the node information associated with the node ND to be added, a write operation for updating the existing node information is needed.

According to the first embodiment, to reduce a ratio R of the write amount for updating the existing node information to the write amount of the node information associated with the node ND to be added, it is defined that two or more nodes ND are to be added to the database device 1 per one round of addition.

When X nodes ND are added per one round of addition, (X+1) write operations of the node information are performed. Accordingly, the ratio R is (X+1)/X. For example, when one node ND is added per one round of addition, the ratio R is 2. Accordingly, when the addition of one node ND per one round of addition is repeated, the amount of data written in the SSD 13, or even each memory die MD, increases. In the first embodiment, where two or more nodes ND are to be added per one round of addition, it is possible to reduce the ratio R to 1.5 or less. In other words, as compared to the case in which one node ND is added per one round of addition, it is possible to reduce the amount of data written in each memory die MD.

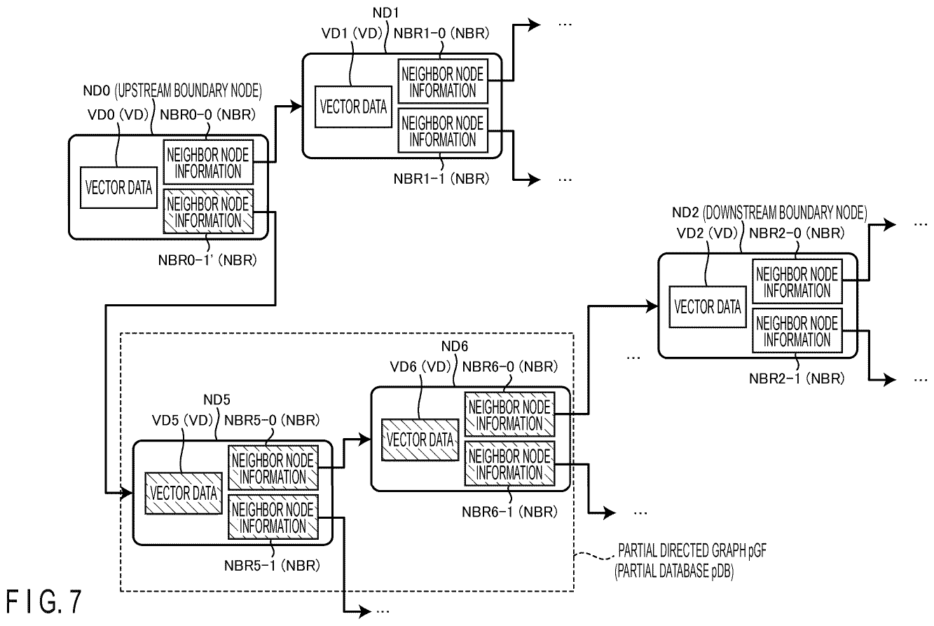

FIG. 7 is a diagram for describing how a new node ND is added according to the first embodiment. Here, description will be made as to the case in which a node ND5 corresponding to vector data VD5 and a node ND6 corresponding to vector data VD6 are added to the vector database DB constituting the directed graph GF illustrated in FIG. 5.

The processor 11 generates one directed graph that includes the vector data VD5 and the vector data VD6 to be added as a node ND respectively (denoted as a partial directed graph pGF). In other words, the processor 11 generates a database corresponding to the partial directed graph pGF (denoted as a partial database pDB) in the DRAM 14.

As in the vector database DB corresponding to the directed graph GF, the partial database pDB includes node information per vector data VD. Then, the node corresponding to the vector data VD is connected to a node corresponding to different vector data VD in accordance with the neighbor node information NBR included in the node information.

In other words, generating a partial database pDB includes: generating a partial directed graph pGF corresponding to a group of vector data VD to be added; and recording node information per node ND included in the partial directed graph pGF.

In the example illustrated in FIG. 7, the partial directed graph pGF includes the node ND5 that is the vector data VD5 and the node ND6 that is the vector data VD6. The node ND5 is connected to the node ND6, and the node ND6 is handled as a neighbor node of the node ND5.

In the partial database pDB, the node information of the node ND5 includes the vector data VD5, neighbor node information NBR5-0, and neighbor node information NBR5-1. The node information of the node ND6 includes the vector data VD6, neighbor node information NBR6-0, and neighbor node information NBR6-1. The neighbor node information NBR5-0 indicates the node ND6.

The processor 11 combines the partial directed graph pGF that now includes two or more nodes ND with the directed graph GF. The processor 11 sets or updates the neighbor node information of one node ND of two nodes ND located across the border between the partial directed graph pGF and the directed graph GF, whichever is on the upstream side, such that the other node ND of the two nodes ND on the downstream side is indicated.

In the example illustrated in FIG. 7, the partial directed graph pGF is added between the node ND0 and the node ND2 of the directed graph GF. As a result, a first border between the node ND0 and the node ND5 and a second border between the node ND6 and the node ND2 are generated as borders between the partial directed graph pGF and the directed graph GF.

With respect to the first border, of two nodes ND0 and ND5 located across the first border, the node ND0 corresponds to the node ND on the upstream side. The contents of the neighbor node information NBR0-1 included in the node information of the node ND0 are updated to the contents indicative of the node ND5. In FIG. 7, the updated neighbor node information NBR0-1 is denoted as neighbor node information NBR0-1′. The processor 11 newly generates node information of the node ND0 that includes the neighbor node information NBR0-1′ in place of the neighbor node information NBR0-1 and writes the generated node information in an available page P to update the neighbor node information NBR0-1.

With respect to the second border, of two nodes ND6 and ND2 located across the second border, the node ND6 corresponds to the node ND on the upstream side. The processor 11 sets the contents indicative of the node ND2 as neighbor node information NBR6-1 included in the node information of the node ND6.

Note that the location where the partial directed graph pGF is added is not limited to the above example. For example, the partial directed graph pGF may be added on the upstream side of the directed graph GF, that is, the upstream side of the node ND0. Alternatively, the partial directed graph pGF may be added on the downstream side of the directed graph GF, that is, for example, the downstream side of the node NDz.

When the partial directed graph pGF is added on the upstream side of the directed graph GF, the processor 11 does not update the node information of the existing node ND included in the directed graph GF. The processor 11 sets the neighbor node information NBR included in the node information of the node ND that is one of two nodes ND located across the combination border and included in the partial directed graph pGF.

When the partial directed graph pGF is added on the downstream side of the directed graph GF, the processor 11 updates the neighbor node information NBR included in the node information of the node ND that is one of two nodes ND located across the combination border and included in the directed graph GF. The processor 11 does not update the node information for the partial directed graph pGF.

One node ND of two nodes ND located across the border between the partial directed graph pGF and the directed graph GF, whichever is on the upstream side, is denoted as an upstream boundary node, and the other node ND on the downstream side is denoted as a downstream boundary node. Furthermore, an operation of setting or updating the neighbor node information of the node information associated with the upstream boundary node such that the downstream boundary node is indicated is denoted as a combining operation.

After the combining operation, the processor 11 stores the partial database pDB in the SSD 13 as it is.

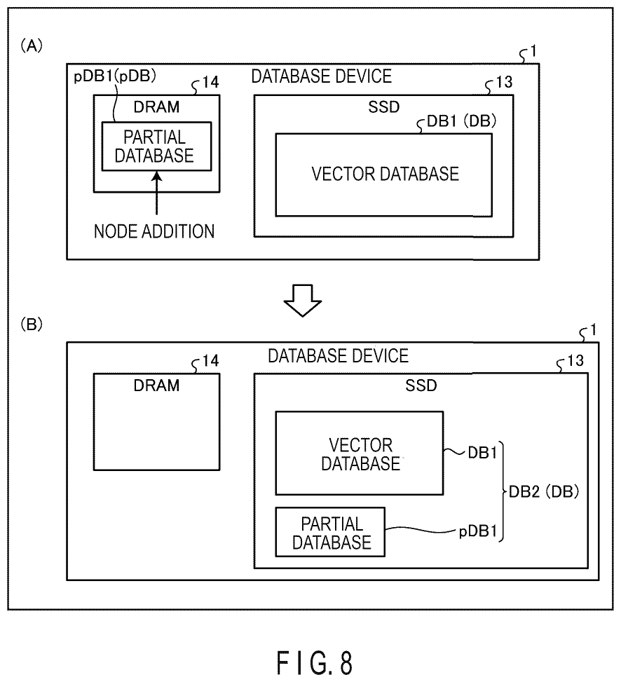

FIG. 8 shows diagrams for describing operations performed by the processor 11, from generating the partial database pDB to storing the partial database pDB in the SSD 13 according to the first embodiment.

Part (A) of FIG. 8 illustrates the states of memories (DRAM 14 and SSD 13) in the course of the partial database pDB being generated. A vector database DB1 is stored in the SSD 13, the vector database DB1 being a vector database DB before the partial database pDB (specifically, a partial database pDB1 described later) is stored in the SSD 13. When new vector data VD is input, the processor 11 generates the partial database pDB1 that includes a node ND corresponding to the input vector data VD in the DRAM 14. Then, every time new vector data VD is input, the processor 11 adds the new node ND to the partial database pDB1.

The processor 11 performs a combining operation for combining the partial database pDB1 with the vector database DB1. After the combining operation, as illustrated in part (B) of FIG. 8, the processor 11 stores the partial database pDB1 in the SSD 13. The processor 11 manages a vector database DB2 obtained by adding the partial database pDB1 to the vector database DB1 as new vector database DB.

After the partial database pDB is stored in the SSD 13, new vector data VD may further be input. When new vector data VD is input, the processor 11 generates a partial database pDB2 that includes a node ND corresponding to the input vector data VD in the DRAM 14. Then, the processor 11 performs a combining operation for combining the partial database pDB2 with the vector database DB2 and stores the partial database pDB2 in the SSD 13.

In this way, the processor 11 repeats an operation for generating the partial database pDB that includes two or more nodes ND in the DRAM 14 and an operation for storing the partial database pDB in the SSD 13. By repeating these operations, the database device 1 allows the vector database DB to grow.

The processor 11 can execute a search operation even in the course of the partial database pDB being generated.

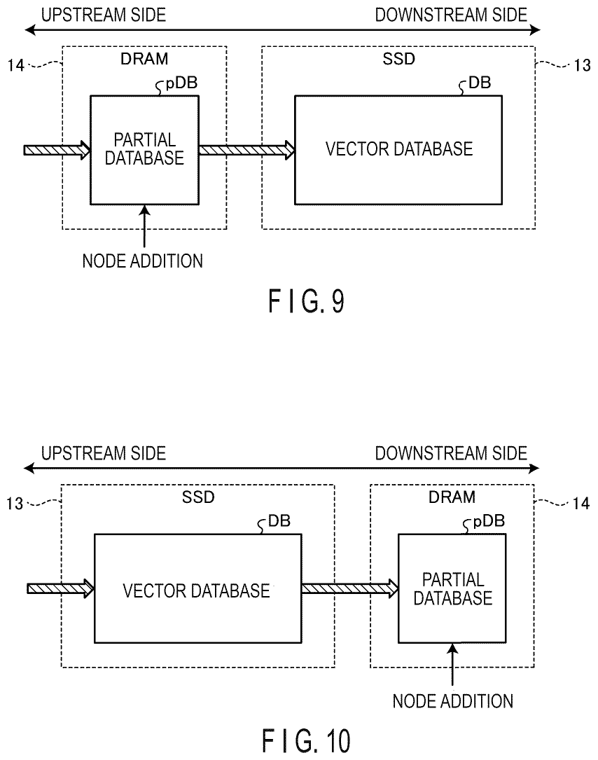

FIGS. 9 to 11 are schematic diagrams for describing the search operation according to the first embodiment. In FIGS. 9 to 11, hatched arrows indicate search directions. A search direction corresponds to a hop direction. In other words, the search direction is a direction from the upstream side to the downstream side of the directed graph.

FIG. 9 is a diagram for describing a search operation when the partial directed graph pGF is added on the upstream side of the directed graph GF.

At the beginning of the generation of the partial database pDB, the processor 11 executes a combining operation for combining the partial database pDB on the upstream side of the vector database DB. The processor 11 then executes addition of the node ND to the partial database pDB in a state in which the combination of the partial database pDB and the vector database DB is maintained.

Since the state in which the partial database pDB is combined on the upstream side of the vector database DB is maintained, when a query is input, the processor 11 can perform hops to a group of nodes ND included in the partial database pDB and a group of nodes ND included in the vector database DB, in this order.

FIG. 10 is a diagram for describing a search operation when the partial directed graph pGF is added on the downstream side of the directed graph GF.

At the beginning of the generation of the partial database pDB, the processor 11 executes a combining operation for combining the partial database pDB on the downstream side of the vector database DB. The processor 11 then executes addition of the node ND to the partial database pDB in a state in which the combination of the partial database pDB and the vector database DB is maintained.

Accordingly, when a query is input, the processor 11 can perform hops to a group of nodes ND included in the vector database DB and a group of nodes ND included in the partial database pDB, in this order.

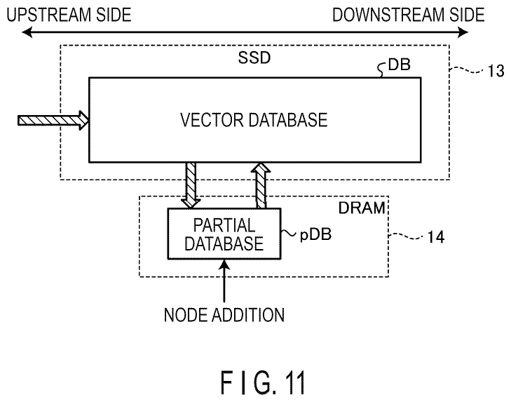

FIG. 11 is a diagram for describing a search operation when the partial directed graph pGF is added to the body portion of the directed graph GF.

At the beginning of the generation of the partial database pDB, the processor 11 executes a combining operation for combining the partial database pDB with the body portion of the vector database DB. The processor 11 then executes addition of the node ND to the partial database pDB in a state in which the combination of the partial database pDB and the vector database DB is maintained.

Accordingly, when a query is input, the processor 11 can perform hops to a group of nodes ND included in the partial database pDB, a group of nodes ND included in the vector database DB, and a group of nodes ND included in the partial database pDB, in this order.

Next, the operation of the database device 1 according to the first embodiment will be described.

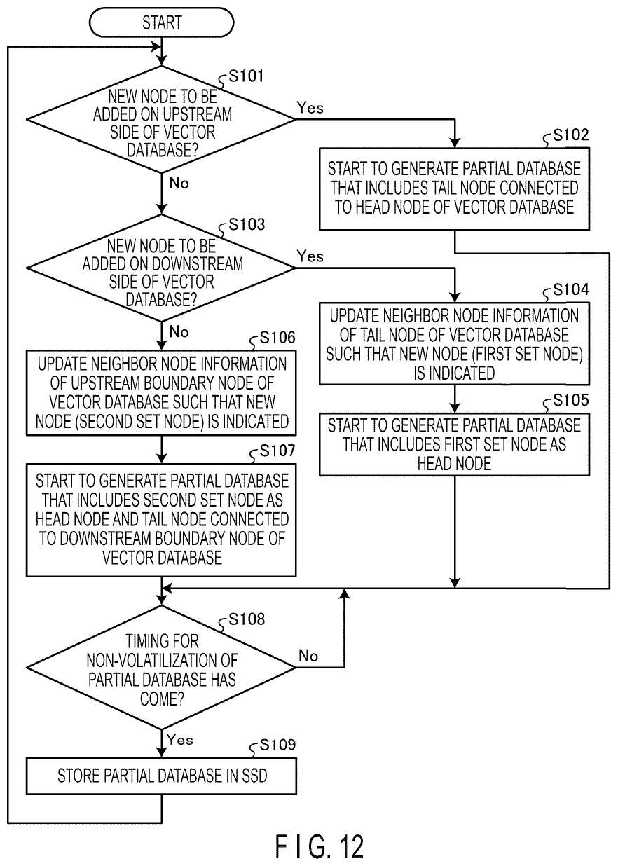

FIG. 12 is a flow chart illustrating an example operation of the database device 1 according to the first embodiment. Here, the operation executed in a state in which the vector database DB is already stored in the SSD 13 will be described. Storing the vector database DB in the SSD 13 is executed by, for example, the processor 11.

The processor 11 determines whether or not a new node is to be added on the upstream side of the vector database DB (S101). The place where the new node is to be added can be set by, for example, the user of the database device 1. Alternatively, the processor 11 may autonomously determine the place where the new node is to be added in any other way.

When the new node is to be added on the upstream side of the vector database DB (S101: Yes), the processor 11 starts to generate a partial database pDB that includes a tail node connected to a head node of the vector database DB (S102). In other words, the processor 11 starts to generate a partial database pDB that is in combination with the vector database DB. The processor 11 generates the partial database pDB in the DRAM 14.

When the new node is not to be added on the upstream side of the vector database DB (S101: No), the processor 11 determines whether or not the new node is to be added on the downstream side of the vector database DB (S103).

When the new node is to be added on the downstream side of the vector database DB (S103: Yes), the processor 11 updates the neighbor node information NBR of the tail node of the vector database DB such that a certain new node ND (denoted as a first set node) is indicated (S104). The processor 11 newly generates node information of the tail node of the vector database DB that includes the neighbor node information NBR that indicates the first set node, and writes the newly generated node information in an available page P of the SSD 13.

The processor 11 starts to generate the partial database pDB that includes the first set node as the head node (S105). Through S104 and S105, the processor 11 generates the partial database pDB that is in combination with the vector database DB in the DRAM 14.

When the new node is not to be added on the downstream side of the vector database DB (S103: No), that is, when the new node is to be added to the body portion of the vector database DB, the processor 11 updates the neighbor node information NBR of the upstream boundary node of the vector database DB such that a certain new node ND (denoted as a second set node) is indicated (S106). The processor 11 newly generates node information of the upstream boundary node that includes neighbor node information NBR that indicates the first set node, and writes the newly generated node information in an available page P of the SSD 13.

The processor 11 starts to generate the partial database pDB that includes the second set node as the head node, and the tail node connected to the downstream boundary node of the vector database DB (S107). Through S106 and S107, the processor 11 generates the partial database pDB that is in combination with the vector database DB in the DRAM 14.

After S102, S105, or S107, the processor 11 determines whether or not a timing for non-volatilization of the partial database pDB has come (S108). A method for determining the timing for non-volatilization of the partial database pDB is not limited to a particular method. The timing for non-volatilization of the partial database pDB may be a timing when the size of the partial database pDB reaches a predetermined value. Alternatively, the timing for non-volatilization of the partial database pDB may be a timing when an instruction is given for the non-volatilization from the user of the database device 1. However, the timing for non-volatilization of the partial database pDB is to be after the number of nodes ND included in the partial database pDB reaches 2 or more.

When the timing for non-volatilization of the partial database pDB has not come yet (S108: No), the processor 11 waits for the timing for non-volatilization of the partial database pDB to come.

When the timing for non-volatilization of the partial database pDB has come (S108: Yes), the processor 11 stores, in the SSD 13, the partial database pDB in the DRAM 14 (S109). Then, the control makes a transition to S101.

As described with reference to FIG. 6, one piece of node information is stored per one page P. Accordingly, in S109, the processor 11 stores each of plural pieces of node information included in the partial database pDB in one different page P.

As described above, according to the first embodiment, the processor 11 generates, in the DRAM 14, the partial database pDB that includes two or more new nodes ND and that is in combination with the vector database DB in the SSD 13. The processor 11 then stores the partial database pDB in the SSD 13.

In this way, as compared to the case in which one node ND is added to the vector database DB at one time, the amount of data written in the SSD 13 can be reduced.

Note that combining the partial database pDB with the vector database DB includes updating or setting the node information of the upstream boundary node of two nodes ND neighboring each other across a border between the partial directed graph pGF and the directed graph GF (for example, see FIG. 7, and S102, S104 to S105, and S106 to S107 of FIG. 12).

Furthermore, in the first embodiment, for example, as illustrated in FIGS. 9 to 11, when a query is input while the partial database pDB is stored in the DRAM 14, the processor 11 uses both the partial database pDB and the vector database DB to search for a node ND closest to the query.

In this way, even before the partial database pDB is stored in the SSD 13, it is possible to perform a search including the partial database pDB in the search range.

Furthermore, in the first embodiment, the processor 11 stores one piece of node information per one page P. For example, when storing the partial database pDB in the SSD 13, the processor 11 also stores one piece of node information per one page P for the partial database pDB.

In this way, time required for reading node information during a search operation can be reduced.

In examples described above, one piece of node information is stored per one page P. The number of pieces of node information stored in one page P is not limited to one. An integer number of pieces of node information may be stored in one page P. However, one piece of node information may not be stored across two or more pages P.

The database device 1 has been described as including the SSD 13 as a storage device. A storage device applicable to the database device 1 is not limited to the SSD. The database device 1 may include a magnetic disk device as the storage device. An example of magnetic disk devices is a hard disk drive (HDD).

### Second Embodiment

In the first embodiment, the partial database pDB that is in combination with the vector database DB is generated in the DRAM 14. In the DRAM 14, a partial database pDB that is not combined with the vector database DB may be generated, followed by the execution of a combining operation for combining the partial database pDB with the vector database DB. In the second embodiment, description will be made as to an example of executing a combining operation immediately before non-volatilization of the partial database pDB. Hereinafter, the matters that are different from those of the first embodiment will be described. The matters that are the same as those of the first embodiment will be described only briefly or the description will not be repeated.

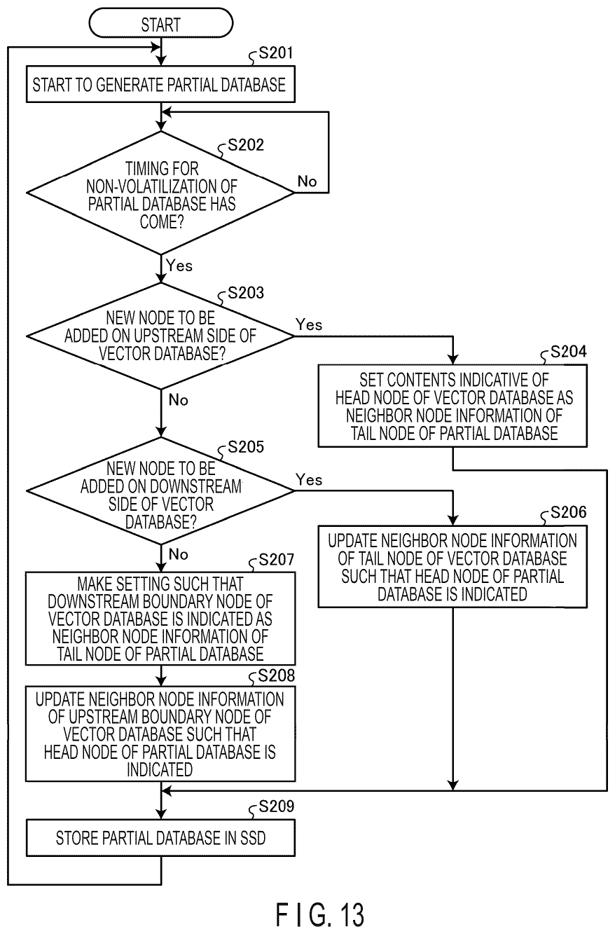

FIG. 13 is a flow chart illustrating an example operation of when a new node is added to the database device 1 according to the second embodiment.

The processor 11 starts to generate the partial database pDB (S201). In S201, the processor 11 generates the partial database pDB that is not combined with the vector database DB in the DRAM 14 and adds new nodes ND sequentially to the partial database pDB in the DRAM 14.

The processor 11 then determines whether or not timing for non-volatilization of the partial database pDB has come (S202). The processor 11 determines that the timing for non-volatilization of the partial database pDB has come, for example, in a similar manner to S108.

When the timing for non-volatilization of the partial database pDB has not come yet (S202: No), the processor 11 waits for the timing for non-volatilization of the partial database pDB to come.

When the timing for non-volatilization of the partial database pDB has come (S202: Yes), the processor 11 determines whether or not the new node is to be added on the upstream side of the vector database DB (S203).

When the new node is to be added on the upstream side of the vector database DB (S203: Yes), the processor 11 sets the contents indicative of the head node of the vector database DB as the neighbor node information NBR of the tail node of the partial database pDB (S204).

When the new node is not to be added on the upstream side of the vector database DB (S203: No), the processor 11 determines whether or not the new node is to be added on the downstream side of the vector database DB (S205).

When the new node is to be added on the downstream side of the vector database DB (S205: Yes), the processor 11 updates the neighbor node information NBR of the tail node of the vector database DB such that the head node of the partial database pDB is indicated (S206). The processor 11 newly generates node information of the tail node of the vector database DB that includes the neighbor node information NBR that indicates the head node of the partial database pDB, and writes the newly generated node information in an available page P of the SSD 13.

When the new node is not to be added on the downstream side of the vector database DB (S205: No), that is, when the new node is to be added to the body portion of the vector database DB, the processor 11 makes a setting such that the downstream boundary node of the vector database DB is indicated as the neighbor node information NBR of the tail node of the partial database pDB (S207). Furthermore, the processor 11 updates the neighbor node information NBR of the upstream boundary node of the vector database DB such that the head node of the partial database pDB is indicated (S208). The processor 11 newly generates node information of the upstream boundary node that includes the neighbor node information NBR that indicates the head node of the partial database pDB, and writes the newly generated node information in an available page P of the SSD 13.

After S204, S206, or S208, the processor 11 stores, in the SSD 13, the partial database pDB in the DRAM 14 (S209). Then, the control makes a transition to S201.

In this way, as long as the partial database pDB is stored in the SSD 13 in combination with the vector database DB, the timing for a combining operation for combining the partial database pDB with the vector database DB is not limited to a particular timing. As illustrated in FIG. 13, the combining operation may be executed immediately before the partial database pDB is stored in the SSD 13.

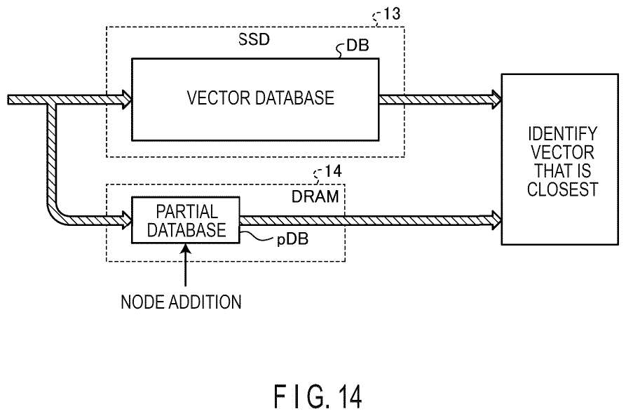

FIG. 14 is a diagram for describing a search operation according to the second embodiment.

In the second embodiment, the partial database pDB is combined with the vector database DB immediately before being stored in the SSD 13. When a query is input before the partial database pDB is combined with the vector database DB, the processor 11 separately executes a first search operation within a search range of the vector database DB in the SSD 13 and a second search operation within a search range of the partial database pDB in the DRAM 14.

The processor 11 then identifies vector data VD of pieces of vector data VD: one obtained by the search operation within a search range of the vector database DB in the SSD 13 and assumed to be closest to the query; and the other obtained by the search operation within a search range of the partial database pDB in the DRAM 14 and assumed to be closest to the query, whichever is closer to the query in the distance, as vector data VD that is closest to the query out of pieces of vector data VD saved in the vector database DB and the partial database pDB.

In this way, before a combining operation is executed, the processor 11 executes the first search operation based on the vector database DB and the second search operation based on the partial database pDB, and identifies a node ND that is closest to the query based on a result of the search based on the vector database DB and a result of the search based on the partial database pDB.

In this way, as in the first embodiment, even before the partial database pDB is stored in the SSD 13, it is possible to perform a search including the partial database pDB in the search range.

### MODIFICATIONS

A few modifications that are applicable to the first embodiment and the second embodiment will now be described.

### Modification 1

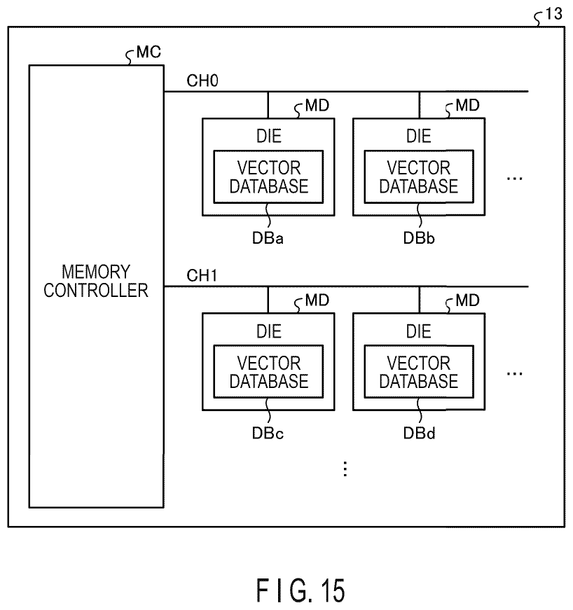

FIG. 15 is a diagram illustrating an example of how the SSD 13 is used in the database device 1 according to a modification 1. In the figure, the memory package PG is not illustrated for simplification of the figure.

In the modification 1, a plurality of vector databases DB that are independent from each other are stored in the SSD 13. Each of the plurality of vector databases DB corresponds to an independent piece of directed graph. Each of the plurality of vector databases DB is an independent vector database that is not combined with any other vector database DB among the plurality of vector databases DB.

Each vector database DB is stored in one memory die MD without being distributed to two or more memory dies MD. In the example illustrated in FIG. 15, a vector database DBa, a vector database DBb, a vector database DBc, and a vector database DBd are cach stored in a different memory die MD.

The memory controller MC can access a plurality of memory dies MD cach connected to a different memory channel CH in a temporally parallel manner. In addition, the memory controller MC can access a plurality of memory dies MD connected to the same channel CH in an interleaving operation in a temporally parallel manner. In other words, the plurality of memory dies MD included in the SSD 13 may be considered as elements accessible in parallel.

In a search operation using the vector database DB, node information is acquired from the vector database DB for each hop. In other words, node information is consecutively read from one vector database DB. When search operations are concurrently performed for each of a plurality of vector databases DB, node information is consecutively read from each of the plurality of vector database DB.

In the modification 1, the plurality of vector databases DB are stored in separate memory dies MD. Accordingly, the memory controller MC can read node information from each of the plurality of vector databases DB in parallel, so that it is possible to increase efficiency of node information acquisition.

### Modification 2

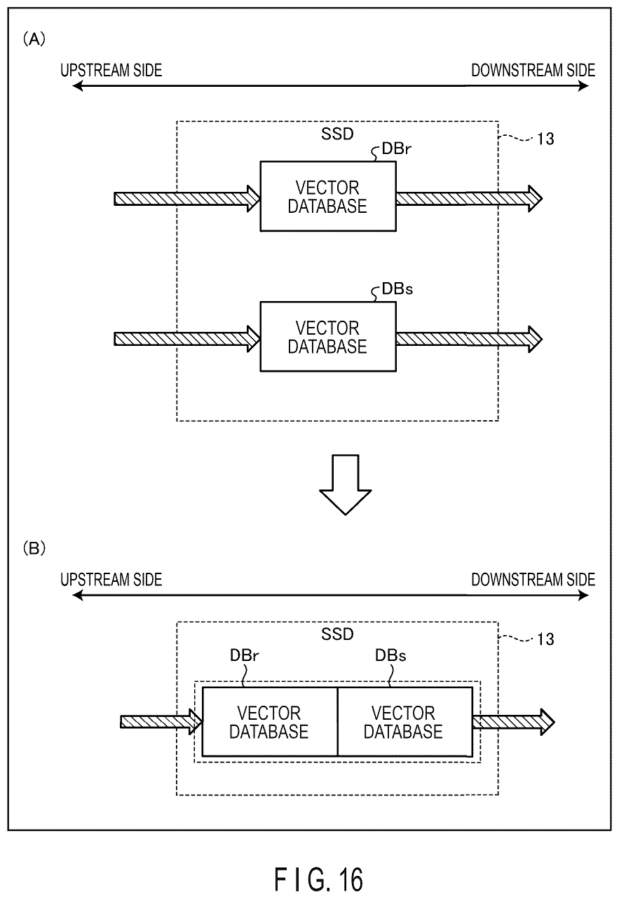

FIG. 16 is a diagram illustrating an example of how the SSD 13 is used in the database device 1 according to a modification 2.

In the modification 2, a plurality of vector databases DB are stored in the SSD 13. In part (A) of the FIG. 16, as an example of the plurality of vector databases DB, a vector database DBr and a vector database DBs are stored in the SSD 13. The processor 11 separately executes a search operation within a search range of the vector database DBr and a search operation within a search range of the vector database DBs.

The processor 11 can execute a combining operation for combining the vector database DBr with the vector database DBs. In the example illustrated in part (B) of FIG. 16, the vector database DBr is combined on the upstream side of the vector database DBs. Accordingly, when a query is input after the combining operation, the processor 11 performs hops to a group of nodes ND included in the vector database DBr and a group of nodes ND included in the vector database DBs, in this order, to identify a node ND that is closest to the query.

### APPENDIX

According to the first and the second embodiments, aspects appended below are provided.

### Appendix 1

There is provided a management method including: storing, in a storage device, a first vector database in which a group of first information pieces cach indicating cach of a plurality of first vectors is recorded, the plurality of first vectors corresponding to a plurality of nodes constituting a first directed graph, each first information piece included in the group of first information pieces including: one of the plurality of first vectors; and a second information piece that indicates a vector corresponding to a neighbor node; while generating a second directed graph that includes two or more nodes corresponding to two or more second vectors, generating, in a volatile memory, a second vector database in which a group of third information pieces cach indicating each of the two or more second vectors is recorded, each third information piece included in the group of third information pieces including: one of the two or more second vectors; and a fourth information piece that indicates a vector corresponding to a neighbor node; combining the first directed graph with the second directed graph by updating or setting at least one information piece of the group of first information pieces and the group of third information pieces; and storing the second vector database in the storage device.

The vector database DB in the SSD 13 (in the example in FIG. 8, the vector database DB1) is an example of the first vector database. Each piece of node information recorded in the vector database DB is an example of the first information piece. The vector data VD included in the node information recorded in the vector database DB is an example of the first vector. The directed graph GF corresponding to the vector database DB is an example of the first directed graph. The neighbor node information NBR included in each piece of node information recorded in the vector database DB is an example of the second information piece.

The partial database pDB generated in the DRAM 14 (in the example in FIG. 8, the partial database pDB1) is an example of the second vector database. Each piece of node information recorded in the partial database pDB is an example of the third information piece. The vector data VD included in the node information recorded in the partial database pDB is an example of the second vector. The partial directed graph pGF corresponding to the partial database pDB is an example of the second directed graph. The neighbor node information NBR included in each piece of node information recorded in the partial database pDB is an example of the fourth information piece.

### Appendix 2

There is provided the management method of Appendix 1, wherein the combining the first directed graph with the second directed graph includes updating or setting an information piece of the group of first information pieces and the group of third information pieces that corresponds to a node of two nodes neighboring each other across a border between the first directed graph and the second directed graph, whichever is on the upstream side.

### Appendix 3

There is provided the management method of Appendix 1 or 2, wherein the generating the second vector database includes combining the first directed graph with the second directed graph, and the method further includes: when a query is input while the second vector database is stored in the volatile memory, searching for a vector that is closest to the query based on the first vector database in the storage device and the second vector database in the volatile memory.

### Appendix 4

There is provided the management method of Appendix 1 or 2, further including, when a query is input while the second vector database is stored in the volatile memory: executing a search for a vector that is closest to the query based on the first vector database in the storage device and a search for a vector that is closest to the query based on the second vector database in the volatile memory; and identifying a vector that is closest to the query based on a result of the search based on the first vector database in the storage device and a result of the search based on the second vector database in the volatile memory.

### Appendix 5

There is provided the management method of Appendix 1, wherein the storage device includes a plurality of unit storage areas, and each of the plurality of unit storage areas corresponds to a unit for data write and data read in the storage device, and wherein the storing, in the storage device, includes storing an integer number of first information pieces included in the group of first information pieces per one unit storage area of the plurality of unit storage areas, and the storing the second vector database in the storage device includes storing an integer number of third information pieces included in the group of third information pieces per one unit storage area of the plurality of unit storage areas.

### Appendix 6

There is provided a database device, including: a storage device that stores a first vector database in which a group of first information pieces cach indicating each of a plurality of first vectors is recorded, the plurality of first vectors corresponding to a plurality of nodes constituting a first directed graph, cach first information piece included in the group of first information pieces including: one of the plurality of first vectors; and a second information piece that indicates a vector corresponding to a neighbor node; a volatile memory; and a processor configured to execute: while generating a second directed graph that includes two or more nodes corresponding to two or more second vectors, generating, in the volatile memory, a second vector database in which a group of third information pieces each indicating each of the two or more second vectors is recorded, cach third information piece included in the group of third information pieces including: one of the two or more second vectors; and a fourth information piece that indicates a vector corresponding to a neighbor node; combining the first directed graph with the second directed graph by updating or setting at least one information piece of the group of first information pieces and the group of third information pieces; and storing the second vector database in the storage device.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. A management method, comprising:
storing, in a storage device, a first vector database in which a group of first information pieces each indicating one of a plurality of first vectors, is recorded, the plurality of first vectors corresponding to a plurality of nodes of a first directed graph, each first information piece included in the group of first information pieces including one of the plurality of first vectors and a second information piece that indicates a vector corresponding to a neighbor node;
while generating a second directed graph that includes two or more nodes corresponding to two or more second vectors, generating, in a volatile memory, a second vector database in which a group of third information pieces each indicating one of the two or more second vectors, is recorded, each third information piece included in the group of third information pieces including one of the two or more second vectors and a fourth information piece that indicates a vector corresponding to a neighbor node;
combining the first directed graph with the second directed graph by updating at least one information piece of the group of first information pieces and the group of third information pieces; and
storing the second vector database in the storage device.

2. The management method of claim 1, wherein
the combining of the first directed graph with the second directed graph includes updating an information piece of the group of first information pieces and the group of third information pieces that corresponds to a node of two nodes neighboring each other across a border between the first directed graph and the second directed graph, whichever is on the upstream side.

3. The management method of claim 2, wherein
the generating of the second vector database includes combining the first directed graph with the second directed graph, and the method further comprises
when a query is input while the second vector database is stored in the volatile memory, searching for a vector that is closest to the query based on the first vector database in the storage device and the second vector database in the volatile memory.

4. The management method of claim 2, further comprising
when a query is input while the second vector database is stored in the volatile memory:
executing a search for a vector that is closest to the query using the first vector database in the storage device and a search for a vector that is closest to the query using the second vector database in the volatile memory; and
identifying a vector that is closest to the query based on a result of the search of the first vector database in the storage device and a result of the search of the second vector database in the volatile memory.

5. The management method of claim 1, wherein
the storage device includes a plurality of unit storage areas, and each of the plurality of unit storage areas corresponds to a unit for data write and data read in the storage device, and wherein
the storing of the first vector database in the storage device includes storing an integer number of first information pieces included in the group of first information pieces per one unit storage area of the plurality of unit storage areas, and
the storing of the second vector database in the storage device includes storing an integer number of third information pieces included in the group of third information pieces per one unit storage area of the plurality of unit storage areas.

6. A database device, comprising:
a storage device that stores a first vector database in which a group of first information pieces each indicating one of a plurality of first vectors, is recorded, the plurality of first vectors corresponding to a plurality of nodes of a first directed graph, each first information piece included in the group of first information pieces including one of the plurality of first vectors and a second information piece that indicates a vector corresponding to a neighbor node;
a volatile memory; and
a processor configured to execute the steps of:
while generating a second directed graph that includes two or more nodes corresponding to two or more second vectors, generating, in the volatile memory, a second vector database in which a group of third information pieces each indicating one of the two or more second vectors, is recorded, each third information piece included in the group of third information pieces including one of the two or more second vectors and a fourth information piece that indicates a vector corresponding to a neighbor node;
combining the first directed graph with the second directed graph by updating at least one information piece of the group of first information pieces and the group of third information pieces; and
storing the second vector database in the storage device.

7. The database device of claim 6, wherein
the combining of the first directed graph with the second directed graph includes updating an information piece of the group of first information pieces and the group of third information pieces that corresponds to a node of two nodes neighboring each other across a border between the first directed graph and the second directed graph, whichever is on the upstream side.

8. The database device of claim 7, wherein
the generating of the second vector database includes combining the first directed graph with the second directed graph, and the method further comprises
when a query is input while the second vector database is stored in the volatile memory, searching for a vector that is closest to the query based on the first vector database in the storage device and the second vector database in the volatile memory.

9. The database device of claim 7, wherein the steps further comprise:
when a query is input while the second vector database is stored in the volatile memory:
executing a search for a vector that is closest to the query using the first vector database in the storage device and a search for a vector that is closest to the query using the second vector database in the volatile memory; and
identifying a vector that is closest to the query based on a result of the search of the first vector database in the storage device and a result of the search of the second vector database in the volatile memory.

10. The database device of claim 6, wherein
the storage device includes a plurality of unit storage areas, and each of the plurality of unit storage areas corresponds to a unit for data write and data read in the storage device, and wherein
the storing of the first vector database in the storage device includes storing an integer number of first information pieces included in the group of first information pieces per one unit storage area of the plurality of unit storage areas, and
the storing of the second vector database in the storage device includes storing an integer number of third information pieces included in the group of third information pieces per one unit storage area of the plurality of unit storage areas.

11. A method of updating a vector database that is stored in a non-volatile memory and is searched in response to a query, the vector database including a plurality of nodes, wherein each of the nodes contain vector information and neighboring node information, said method comprising the steps of:
adding a new node to a partial database that is stored in a volatile memory;
determining a location of the new node with respect to other nodes of the vector database and the partial database;
based on the location of the new node, updating neighboring node information of one of the nodes in the vector database and the partial database, neighboring node information of the new node, or both; and
storing the partial database in the non-volatile memory when the number of nodes in the partial database is greater than a threshold number that is at least 2.

12. The method of claim 11, further comprising:
performing an approximate nearest neighbor search to locate one of the nodes in the vector database and the partial database that is nearest to the new node.

13. The method of claim 11, wherein
the non-volatile memory includes a plurality of unit storage areas, and each of the plurality of unit storage areas corresponds to a unit for data write and data read, and
the updating of the neighboring node information of one of the nodes in the vector database includes writing to a new unit storage area of the non-volatile memory.

14. The method of claim 13, wherein
the vector information and the neighboring node information of any one node of the vector database and the partial database is stored in no more than one unit storage area.

15. The method of claim 11, further comprising:
in response to a query, performing a search of the vector database and the partial database for a node that is nearest to the query.
